(19) United States
(12) Patent Application Publication
(10) Pub. No.: US 2019/0122524 A1
(43) Pub. Date: Apr. 25, 2019

(54) Portable Safety Assembly

(71) Applicant: Ray Milhem, McMurray, PA (US)

(72) Inventor: Ray Milhem, McMurray, PA (US)

(21) Appl. No.: 15/789,661

(22) Filed: Oct. 20, 2017

(51) Int. Cl. G08B 21/04

(52) U.S. Cl. CPC G08B 21/0469

(57) ABSTRACT

A portable safety assembly for alerting a user to a potential threat includes a housing that may be worn on an article of clothing. A processor is positioned within the housing and a proximity sensor is positioned within the housing. The proximity sensor detects motion within a trigger distance of the housing. A plurality of light emitters is each coupled to the outer wall of the housing. Each of the light emitters selectively emits light outwardly therefrom when the proximity sensor detects motion. In this way the plurality of light emitters alert a user to a potential threat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to safety devices and more particularly pertains to a new safety device for alerting a user to a potential threat.

### BRIEF SUMMARY OF THE INVENTION

An embodiment of the disclosure meets the needs presented above by generally comprising a housing that may be worn on an article of clothing. A processor is positioned within the housing and a proximity sensor is positioned within the housing. The proximity sensor detects motion within a trigger distance of the housing. A plurality of light emitters is each coupled to the outer wall of the housing. Each of the light emitters selectively emits light outwardly therefrom when the proximity sensor detects motion. In this way the plurality of light emitters alert a user to a potential threat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a portable safety assembly according to an embodiment of the disclosure.

FIG. 2 is a back view of an embodiment of the disclosure.

FIG. 3 is a right side view of an embodiment of the disclosure.

FIG. 4 is a front phantom view of an embodiment of the disclosure.

FIG. 5 is a perspective in-use view of an embodiment of the disclosure.

### DETAILED DESCRIPTION OF THE INVENTION

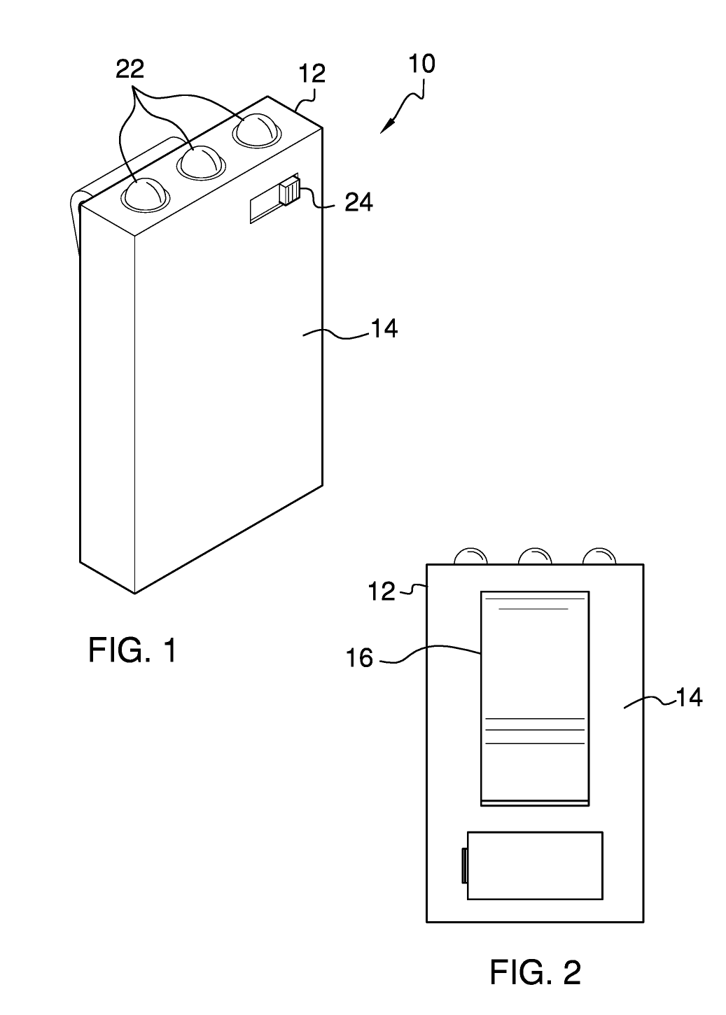

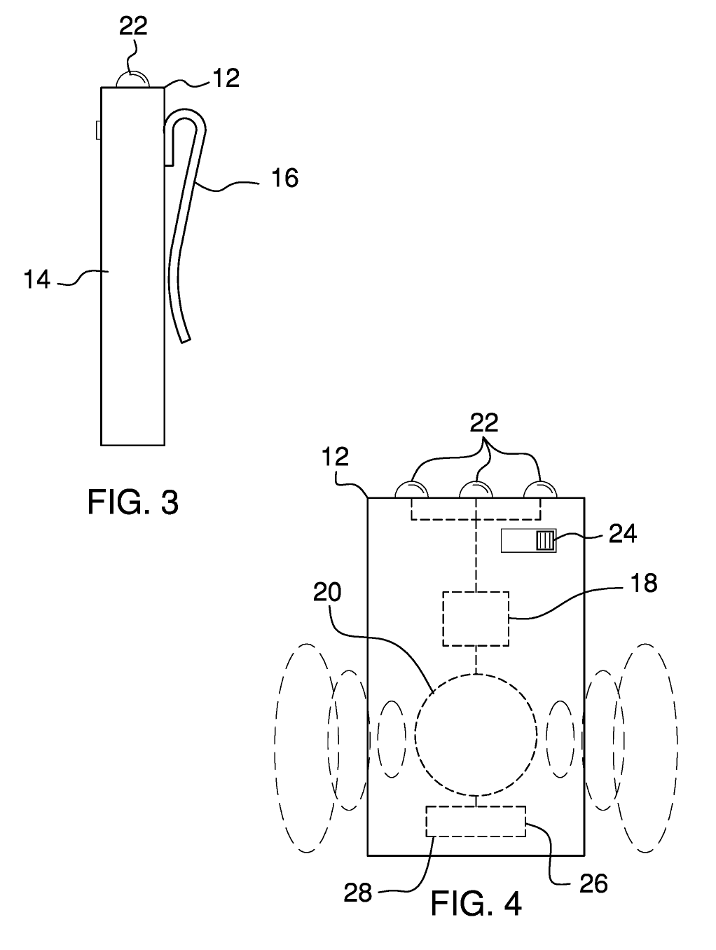

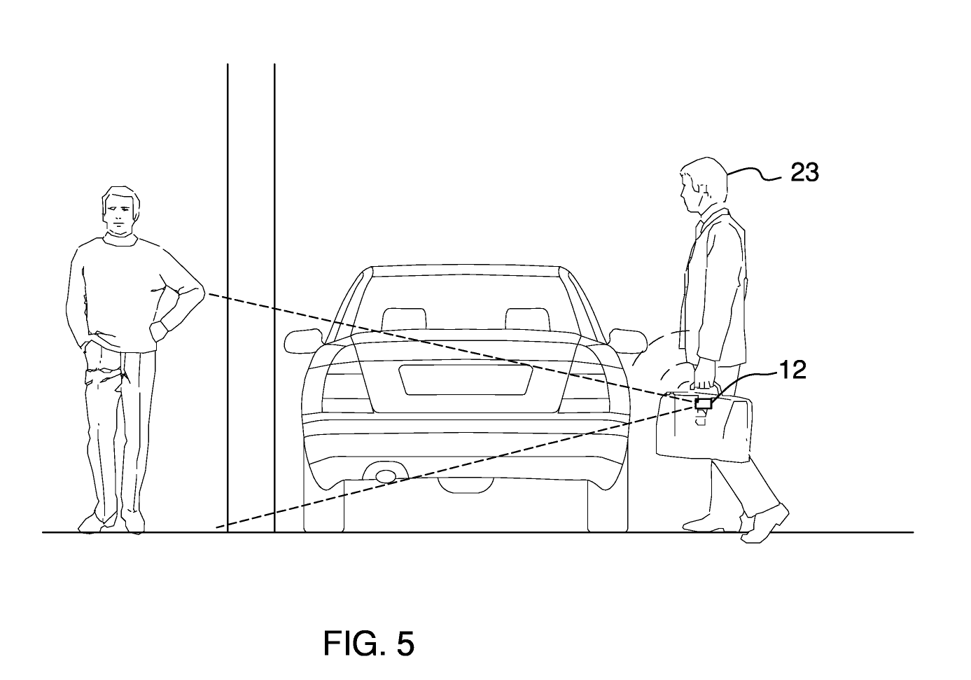

With reference now to the drawings, and in particular to FIGS. 1 through 5 thereof, a new safety device embodying the principles and concepts of an embodiment of the disclosure and generally designated by the reference numeral 10 will be described.

As best illustrated in FIGS. 1 through 5, the portable safety assembly 10 generally comprises a housing 12 that may be worn on an article of clothing. The housing 12 has an outer wall 14 and a clip 16 is coupled to the outer wall 14 of the housing 12. The clip 16 is spaced from the outer wall 14 to facilitate the article of clothing to be positioned between the clip 16 and the housing 12. In this way the clip 16 retains the housing 12 on the article of clothing. The article of clothing may be a waist line of pants, a pocket and any other article of clothing that has an exposed edge.

A processor 18 is positioned within the housing 12 and the processor 18 selectively generates an alarm sequence. The processor 18 may be an electronic processor 18 or the like. A proximity sensor 20 is coupled to the housing 12 and the proximity sensor 20 detects motion within a trigger distance of the housing 12. The processor 18 generates the alarm sequence when the proximity sensor 20 detects motion within the trigger distance. Moreover, the proximity sensor 20 may be an infra-red motion sensor, a laser light motion sensor and any other type of electronic motion sensor. Additionally, the trigger distance may be a distance ranging between approximately 4.0 m and 9.0 m.

A plurality of light emitters 22 is provided and each of the light emitters 22 is coupled to the outer wall 14 of the housing 12. Each of the light emitters 22 selectively emits light outwardly therefrom and each of the light emitters 22 is electrically coupled to the processor 18. Each of the light emitters 22 is turned on when the processor 18 generates the alarm sequence to alert a user 23 to a potential threat. The potential threat may be an individual that is waiting to attack the user 23 or the like. Each of the light emitters 22 may be an LED or the like. Each of the light emitters 22 may be positioned on a top side of the housing 12.

A switch 24 is movably coupled to the outer wall 14 of the housing 12 and the switch 24 is selectively manipulated. The switch 24 is electrically coupled to the processor 18 such that the switch 24 turns the processor 18 on and off. A power supply 26 is positioned within the housing 12. The power supply 26 is electrically coupled to the power supply 26 and the power supply 26 comprises at least one battery 28. A battery cover may be removably coupled to the outer wall 14 of the housing 12 and the power supply 26 may be positioned beneath the battery cover.

In use, the housing 12 is positioned on the article of clothing and the switch 24 is manipulated to turn the processor 18 on when the user 23 is walking in a darkened, unpopulated environment, such as a parking garage or the like. The processor 18 generates the alarm sequence when the proximity sensor 20 detects motion within the trigger distance of the housing 12. Thus, the light emitters 22 are turned on thereby alerting the user 23 to a potential threat with respect to being attacked or the like. In this way the user's 23 safety is enhanced with respect to walking in the darkened, unpopulated environment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable safety assembly being configured to detect hidden threats thereby alerting a user to the hidden threats, said assembly comprising:
a housing being configured to be worn on an article of clothing;
a processor being positioned within said housing;
a proximity sensor being coupled to said housing, said proximity sensor being configured to detect motion within a trigger distance of said housing;
a plurality of light emitters, each of said light emitters being coupled to said outer wall of said housing wherein each of said light emitters is configured to selectively emit light outwardly when said proximity sensor detects motion thereby facilitating said plurality of light emitters to alert a user to a potential threat; and
a clip being coupled to an outer wall of said housing wherein said clip is configured to engage the article of clothing, said clip being spaced from said outer wall wherein said clips configured to facilitate the article of clothing to be positioned between said clip and said housing.

2. (canceled)

3. The assembly according to claim 1, wherein said processor selectively generates an alarm sequence, said processor generating said alarm sequence when said proximity sensor detects motion within the trigger distance.

4. The assembly according to claim 3, wherein each of said light emitters is electrically coupled to said processor, each of said light emitters being turned on when said processor generates said alarm sequence.

5. The assembly according to claim 4, further comprising a switch being movably coupled to said outer wall of said housing wherein said switch is configured to be manipulated, said switch being electrically coupled to said processor such that said switch turns said processor on and off.

6. The assembly according to claim 5, further comprising a power supply being positioned within said housing, said power supply being electrically coupled to said power supply, said power supply comprising at least one battery.

7. A portable safety assembly being configured to detect hidden threats thereby alerting a user to the hidden threats, said assembly comprising:
a housing being configured to be worn on an article of clothing, said housing having an outer wall;
a clip being coupled to said outer wall of said housing wherein said clip is configured to engage the article of clothing, said clip being spaced from said outer wall wherein said clips configured to facilitate the article of clothing to be positioned between said clip and said housing;
a processor being positioned within said housing, said processor selectively generating an alarm sequence;
a proximity sensor being coupled to said housing, said proximity sensor being configured to detect motion within a trigger distance of said housing, said processor generating said alarm sequence when said proximity sensor detects motion within the trigger distance;
a plurality of light emitters, each of said light emitters being coupled to said outer wall of said housing wherein each of said light emitters is configured to selectively emit light outwardly therefrom, each of said light emitters being electrically coupled to said processor, each of said light emitters being turned on when said processor generates said alarm sequence wherein said plurality of light emitters is configured to alert the user to a potential threat;
a switch being movably coupled to said outer wall of said housing wherein said switch is configured to be manipulated, said switch being electrically coupled to said processor such that said switch turns said processor on and off; and
a power supply being positioned within said housing, said power supply being electrically coupled to said power supply, said power supply comprising at least one battery.
